(19) United States
(12) Patent Application Publication
(10) Pub. No.: US 2017/0124347 A1
(43) Pub. Date: May 4, 2017

(54) INFORMATION PROCESSING APPARATUS, INFORMATION PROCESSING METHOD, AND RECORDING MEDIUM

(71) Applicant: Takehiro KAMATA, Tokyo (JP)

(72) Inventor: Takehiro KAMATA, Tokyo (JP)

(73) Assignee: Ricoh Company, Ltd., Tokyo (JP)

(21) Appl. No.: 15/295,220

(22) Filed: Oct. 17, 2016

(30) Foreign Application Priority Data
Nov. 4, 2015 (JP) 2015-216632

(51) Int. Cl. G06F 21/62; G06F 19/00; H04N 1/44; G06K 9/00; H04N 1/00; G06Q 10/10; G06F 17/30

(52) U.S. Cl. CPC G06F 21/6218; G06Q 10/10; G06F 19/322; G06F 19/345; G06F 17/30011; G06F 17/30675; G06K 9/00456; G06K 9/00469; H04N 1/00872; H04N 1/4493; H04N 2201/0094; H04N 2201/0012; H04N 2201/0039

(57) ABSTRACT

An information processing apparatus is communicably connected to an information management system. The apparatus includes circuitry configured to generate intermediate data of a document in response to receiving a request for outputting the document; query the information management system for confidential information relevant to the document; delete the confidential information contained in the intermediate data, the confidential information being determined based on a result of the query from the information management system; and issue an output request for performing output processing based on the intermediate data having the confidential information deleted.

### CROSS-REFERENCE TO RELATED APPLICATIONS

This patent application is based on and claims priority pursuant to 35 U.S.C. §119(a) to Japanese Patent Application No. 2015-216632, filed on Nov. 4, 2015 in the Japan Patent Office, the entire disclosure of which are hereby incorporated by reference herein.

### BACKGROUND

Technical Field

The present disclosure relates to an information processing apparatus, an information processing method, and a non-transitory recording medium.

Description of the Related Art

Document management systems capable of operating in cooperation with medical information systems such as electronic health record systems and diagnostic support systems are in widespread use in medical institutions. Further, software is provided, enabling a user to store printing data in a document management system in a document file format in response to a print request from an application. The document stored in the document management system can be retrieved by a user using an information management system such as the medical information system to view the document or print it out.

However, it is not preferable that the stored document is printed out or output as a document file with confidential information such as personal information. Accordingly, when the user uses a document that may include the confidential information, the user wants the confidential information to be prevented from being output unintentionally.

### SUMMARY

An information processing apparatus is communicably connected to an information management system. The apparatus includes circuitry configured to generate intermediate data of a document in response to receiving a request for outputting the document; query the information management system for confidential information relevant to the document; delete the confidential information contained in the intermediate data, the confidential information being determined based on a result of the query from the information management system; and issue an output request for performing output processing based on the intermediate data having the confidential information deleted.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic view illustrating a network environment of a printing system according to an embodiment of the present invention;

FIG. 2 is a block diagram illustrating a hardware configuration of a client terminal according to an embodiment of the present invention;

FIG. 3 is a block diagram illustrating a software configuration of the client terminal according to an embodiment of the present invention;

FIGS. 4A and 4B are views, each illustrating a configuration of a software package for implementing the client terminal according to an embodiment of the present invention;

FIG. 5 is a block diagram illustrating a software configuration of the client terminal on which the software package illustrated in FIG. 4B is installed;

FIG. 6 is a block diagram illustrating functional blocks relevant to redaction process implemented on the client terminal according to an embodiment of the present invention;

FIG. 7 is an outline sequence diagram illustrating the redaction process performed by the client terminal according to an embodiment of the present invention;

FIG. 8 is a block diagram illustrating detailed functional blocks relevant to the redaction process implemented on the client terminal according to an embodiment of the present invention;

FIGS. 9A and 9B are illustrations of a data structure of area designation information according to an embodiment of the present invention;

FIGS. 10A and 10B are a flowchart illustrating a detailed operation of the redaction process performed by the client terminal according to an embodiment of the present invention;

FIG. 11 is a view illustrating an example of a document-type-list screen according to an embodiment of the present invention;

FIG. 12 is a view illustrating an example of a document-type setting screen according to an embodiment of the present invention;

FIG. 13 is a block diagram illustrating functional blocks relevant to redaction process implemented on the client terminal according to another embodiment of the present invention, and

FIG. 14 is a view illustrating an example of an output preview screen according to another embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Several exemplary embodiments of the present invention are described hereinafter with reference to drawings.

In the embodiments described hereinafter, a description is given of a printing system 100 as an example of an information processing system. However, the printing system 100 is just one example of the information processing system. The embodiments of the present invention are applicable to any system that performs an output operation such as printing, displaying, and projecting.

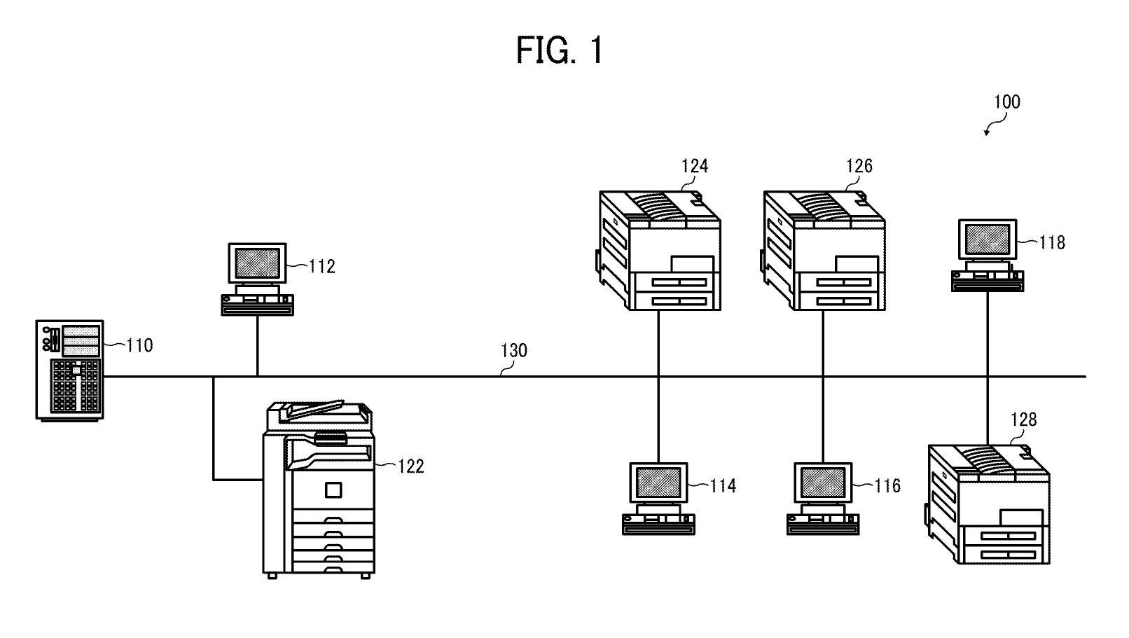

FIG. 1 is a schematic diagram illustrating a network environment of the printing system 100 according to one embodiment. The printing system 100 includes client terminals 112, 114, 116, 118, which are located in, for example, medical institutions or offices; printers such as a multifunction peripheral (MFP) 122, laser printers 124, 126, and an inkjet printer 128; and a document management system 110. Hereinafter, for simplicity, the MFP 122, the laser printers 124, 126, and the inkjet printer 128 are collectively referred to as a “printer”.

In the present embodiment, the document management system 110, the client terminals 112, 114, 116, 118, and the printers 122, 124, 126, 128 communicate with each other by packet communication based on the TCP/IP protocol. The network 130 may be, for example, a wired network such as the 1000Base-TX Ethernet, or a wireless network in compliance with the IEEE 802.11 standard.

The document management system 110 manages documents that the printing system 100 can support. In the embodiment described herein, the printing system 100 includes a single document management apparatus (document management system 110). However, alternatively the printing system 100 may include a plurality of document management apparatuses, or may include a plurality of types of document management apparatuses.

The document management system 110 is an information management system such as a medical information system that manages medical information including diagnosis information of patients and patient names. Hereinafter, a description is given of an example case in which the document management system 110 is implemented by the medical information system. However, for example, a person who manages the system may decide how the document management system is configured in the printing system 100. This embodiment may be applied to any numbers and any types of document management systems.

In this embodiment, the client terminals 112 to 118 invokes a printer driver corresponding to a specified or determined printer to issue a print request for a document acquired from the document management system 110 to the printer.

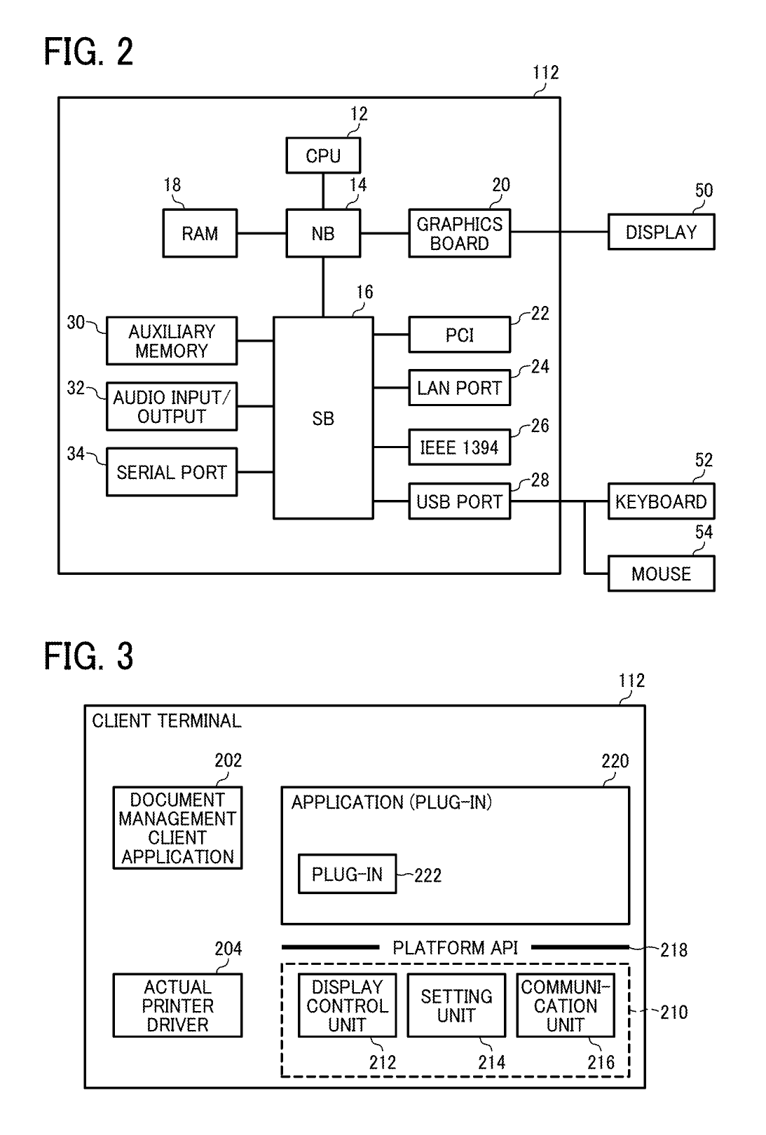

Hereinafter, a description is given of hardware configurations of the client terminals 112 to 118 with reference FIG. 2. Since the client terminals 112 to 118 have the same or substantially the same configuration, a description is given of just the client terminal 112 as a typical example. FIG. 2 is a block diagram illustrating a hardware configuration of the client terminal 112. The client terminal 112 is implemented by, for example, a general-purpose computer.

As illustrated in FIG. 2, the client terminal 112 includes a central processing unit (CPU) 12, a north bridge that connects the CPU 12 to a memory, and a south bridge 16. The south bridge 16 is connected to the north bridge 14 via a dedicated bus or a peripheral component interconnect (PCI) bus to connect the north bridge 14 with input/output devices such as a PCI bus and a universal serial bus (USB).

The client terminal 112 further includes a random access memory (RAM) 18 and a graphics board 20, which are connected to the north bridge 14. The RAM 18 provides a work area for the CPU 12. The graphics board outputs video signals. The graphics board 20 is connected to a display 50 via a video output interface.

The client terminal 112 further includes a PCI 22, a LAN port 24, an IEEE 1394 port 26, a USB port 28, an auxiliary memory 30, an audio input and output 32, and a serial port 34, which are connected to the south bridge 16. The auxiliary memory 30 is implement by, for example, a hard disc drive (HDD) or a solid state drive (SSD). The auxiliary memory 30 stores an operating system for controlling the client terminal 112, a program for implementing functional blocks described below, various system information, and various setting information. The LAN port 24 is an interface device that connects the client terminal 112 to the network by wired or wireless communication.

The client terminal may include one or more input devices connected to the USB port 28. Examples of the input device include a keyboard 52 and a mouse 54. The client terminal 112 according to this embodiment reads out the program from the auxiliary memory 30 and loads the program to the work area provided by the RAM 18 to implement each of functional block and operations described below, under control of the CPU 12. Note that the document management system 110 and the printer 122 to 128 each also includes hardware such as a CPU and a RAM, and dedicated hardware, and descriptions thereof are omitted.

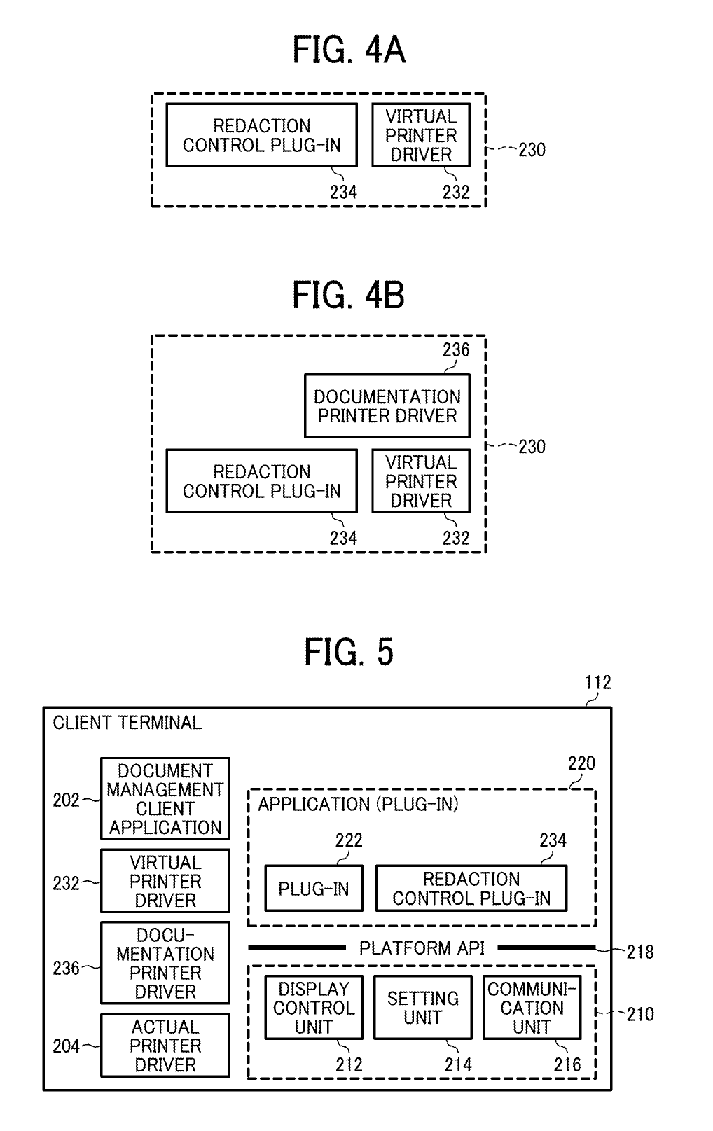

Hereinafter, a description is given of a software configuration of the client terminal 112 according to this embodiment with reference to FIGS. 3 to 5. FIG. 3 is a block diagram illustrating the software configuration of the client terminal 112 on which a software package described later has not yet been installed. FIGS. 4A and 4B are block diagrams, each illustrating a configuration of the software package described later. FIG. 5 is a block diagram illustrating the software configuration of the client terminal 112 on which the software package illustrated in FIG. 4B is installed.

The client terminal 112 illustrated in FIG. 3 includes a document management client application 202, an actual printer driver 204, a platform 210, a platform application programming interface (API) 218, and an application (plug-in) 220.

The document management client application 202 is an application that enables the client terminal 112 to access the document management system 110 to search for the document managed in the document management system 110 for viewing and printing out. The document management client application 202 receives the print request for a predetermined document from the user.

The actual printer driver 204 generates actual print data in a format that can be printed out by the printer 122 in response to the print request. Further, the actual printer driver 204 outputs the generated actual print data to the printer 122. Hereinafter, although a description is given of just the printer 112 as a typical example that cooperates with the client terminal 112, the same or the substantially the same description applies to the other printers 124 to 128. Examples of the actual print data include RAW format data. Further, the actual printer driver 204 may generate an electronic document in a predetermined format in response to the print request, to output the electronic document.

The application (plug-in) 220 includes at least one plug-in 222. The plug-in 222 is software that operates on the platform 210. The plug-in 222 supports various functions of the platform 210 via the platform API 218.

The platform API 218 provides an interface for enabling the plug-in 222 to use various functions of the platform 210. The platform API 218 is a predefined interface to enable the platform 210 to receive requests from the plug-in 222. Specifically, the platform API 218 includes multiple functions and classes.

The platform 210 includes a display control unit 212, a setting unit 214, and a communication unit 216. The display control unit 212 of the platform 210 controls display on the display 50 in response to requests from the document management client application 202 and the plug-in 222, for example. The setting unit 214 makes settings for the plug-in 222. The communication unit 216 communicates with external systems such as the document management system 110.

The client terminal 112 aggregates common functions used by the plug-in 222 in the platform 210 to aggregate processing. Note that the software configuration illustrated in FIG. 3 is just one example. The client terminal 112 does not necessarily have the software configuration in the form as illustrated in FIG. 3, and alternatively may have other software configurations.

FIG. 4A illustrates a configuration of a software package 230 for implementing the client terminal 112 according to an embodiment. The software package 230 illustrated in FIG. 4A includes a virtual printer driver 232, and a redaction control plug-in 234. Note that the software package 230 may include one or more other plug-ins such as a document registration plug-in.

The redaction control plug-in 234 communicates with the document management system 110 to perform processing for redacting confidential information included in a document specified by the print request and printing out the document. A detailed description is given later of the redaction control plug-in 234 and the redaction process performed by the redaction control plug-in 234.

The virtual printer driver 232 is a printer driver that converts application data of an application such as the document management client application 202 to intermediate data that is machine independent, and outputs the intermediate data. The intermediate data is print data that is independent of the type of printer. Examples of the intermediate data include data in the XML paper specification (XPS) format. An XPS file contains text and images constituting the document, and position information of the text and the images in the document.

FIG. 4B illustrates a configuration of the software package 230 for implementing the client terminal 112 according to another embodiment. The software package 230 illustrated in FIG. 4B includes a documentation printer driver 236 in addition to the virtual printer driver 232 and the redaction control plug-in 234. The documentation printer driver 236 is a printer driver that generates electronic document data in a format to be registered in the document management system 110 and outputs the generated electronic document data. Examples of the format of the electronic document data include a portable document format (PDF).

FIG. 5 is a block diagram illustrating the software configuration of the client terminal 112 on which the software package 230 illustrated in FIG. 4B is installed according to this embodiment. Compared with the client terminal 112 illustrated in FIG. 3, the client terminal 112 illustrated in FIG. 5 has the components contained in the software package 230 illustrated in FIG. 4B.

More specifically, compared with the client terminal 112 illustrated in FIG. 3, the virtual printer driver 232, the redaction control plug-in 234, and the documentation printer driver 236 are added to the client terminal 112 illustrated in FIG. 5. Further, the redaction control plug-in 234 is incorporated as software that operates on the platform 210.

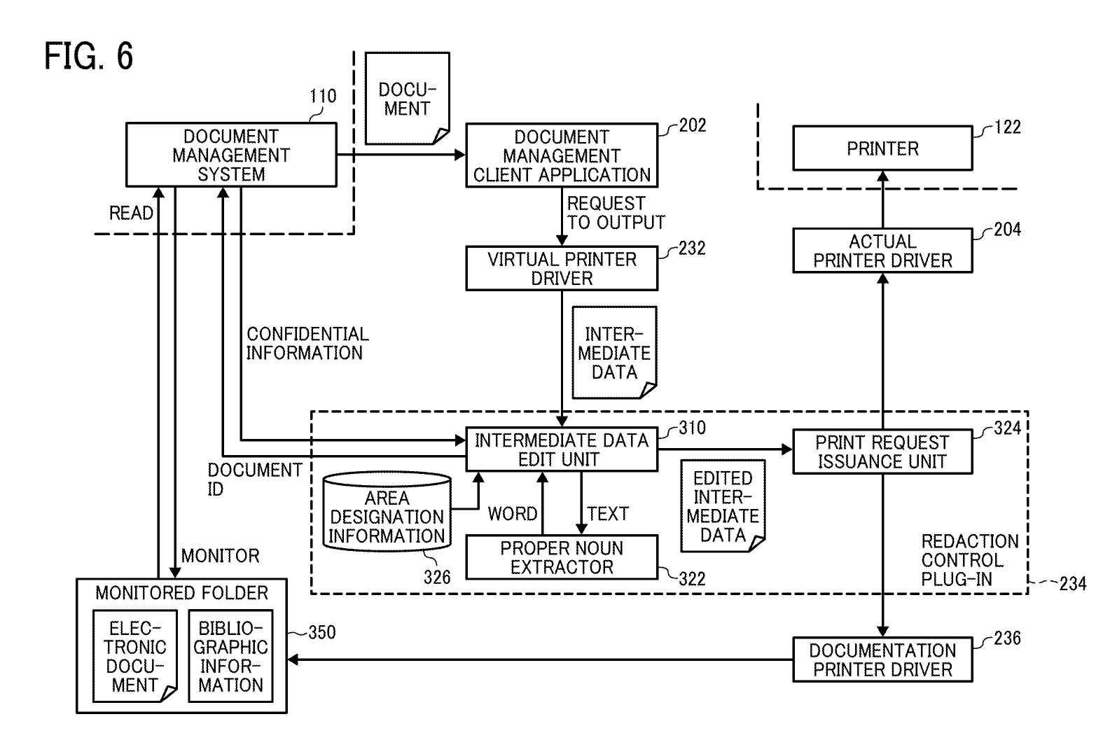

Hereinafter, a description is given of the redaction process according to this embodiment with reference to FIGS. 6 to 12. FIG. 6 is a block diagram illustrating functional blocks relevant to the redaction process implemented on the client terminal 112.

As illustrated in FIG. 6, the functional blocks relevant to the redaction process are the document management client application 202, the actual printer driver 204, the virtual printer driver 232, the redaction control plug-in 234, and the documentation printer driver 236. In FIG. 6, it is assumed that these functional blocks operate on the client terminal 112. Further, FIG. 6 illustrates the document management system 110 and the printer. One broken line in the upper left corner of FIG. 6 represents a network boundary between the functional blocks on the client terminal 112 and the document management system 110. The other broken line in the upper right corner represents a network boundary between the functional blocks on the client terminal 112 and the printer 122.

As described above, the document management system 110 manages documents that the printing system 100 can support. The document management client application 202 is an application for searching the document management system 110 for the document, and viewing and printing out the document. The virtual printer driver 232 is a printer driver that converts application data of various applications including the document management client application 202 to the machine-independent intermediate data and outputs the intermediate data.

In the embodiments described herein, a description is given assuming that the document management client application 202, the actual printer driver 204, the virtual printer driver 232, the redaction control plug-in 234, and the documentation printer driver 236 operate on the client terminal 112. Alternatively, in another embodiment, these functional blocks may be configured on a terminal server that provides a thin client with a desktop environment. In a still another embodiment, the actual printer driver 204, the virtual printer driver 232, the redaction control plug-in 234, and the documentation printer driver 236 may be installed on a print server, while the virtual printer driver 232 is installed on the client terminal 112 on which the document management client application 202 operates, using the point and print technique.

The virtual printer driver 232 is recognized on the operating system of the client terminal 112 in substantially the same manner as a typical printer device. Accordingly, the user is able to select the virtual printer driver 232 from a list of printers such as a printing dialog an application to instruct printing output. The user uses the application 202 to access the document management system 110 and specify the virtual printer driver 232 to give an instruction for printing out a predetermined document. In response to the user instruction, the application 202 requests the virtual printer driver 232 to perform output processing based on the application data.

In response to receiving the output request from the application 202, the virtual printer driver 232 converts the application data to the machine-independent intermediate data. Further, the virtual printer driver 232 outputs the intermediate data to notify the redaction control plug-in 234 of the intermediate data.

The redaction control plug-in 234 is a printing application that performs the redaction process on the intermediate data generated by the printer driver. Further, the redaction control plug-in 234 requests a predetermined printer driver to output the intermediate data on which the redaction process has been performed. More specifically, the redaction control plug-in 234 includes an intermediate-data edit unit 310, a proper noun extractor 322, a print request issuance unit 324, and an area designation information 326.

The intermediate-data edit unit 310 extracts text contained in the generated intermediate data and the position information of the text. Further, the intermediate-data edit unit 310 edits the intermediate data such that predetermined information contained in the text in the intermediate data is redacted. More specifically, the intermediate-data edit unit 310 according to this embodiment queries the document management system 110 for the confidential information relevant to the document designated by the print request. Further, the intermediate-data edit unit 310 deletes the confidential information contained in the intermediate data based on the query result. A detailed description is given later of the intermediate-data edit unit 310.

The proper noun extractor 322 analyzes the text received from the intermediate-data edit unit 310 using morphological analysis or pattern matching to send the extraction result containing the proper noun back to the intermediate-data edit unit 310. Examples of the proper noun include a person's name such as a patient name and a doctor name, and an organization name such as a hospital name. Specific names such as the patient's name, the doctor's name, and the hospital's name may be stored in a dictionary to improve a detection rate. In an embodiment, the intermediate-data edit unit 310 passes the text contained in the intermediate data to the proper noun extractor 322 to acquire the extraction result. Further, the intermediate-data edit unit 310 retrieves the confidential information based on the extraction result and deletes the confidential information by redaction or replacement. With this configuration, the confidential information can be detected more precisely and effectively compared with a typical text search.

The area designation information 326 includes designation information that specifies an area to be searched in the intermediate data, and an area from which the information to be extracted. In an embodiment, the intermediate-data edit unit 310 extracts the text to be analyzed in later processing with reference to the area designation stored in the area designation information 326. Thus, the confidential information is deleted from the intermediate data without searching the full text in the document. Especially in dealing with a document having a template format such as forms, the area to be searched is defined in advance in association with each type of form to enable the intermediate-data edit unit 310 to detect the confidential information effectively depending on the type of form. A detailed description is given later of the area designation information 326.

The print request issuance unit 324 issues the print request to the actual printer driver 204 based on the edited intermediate data from which the confidential information has been deleted. Alternatively, the print request issuance unit 324 issues a documentation request to the documentation printer driver 236 based on the edited intermediate data, instead of or together with the issuance of the print request to the actual printer driver 204. The actual printer driver 204 and the documentation printer driver 236 are examples of an output processing unit according to the present embodiment.

In response to the print request from the print request issuance unit 324, the actual printer driver 204 generates the actual print data and outputs the actual print data to the printer 122. In response to the documentation request from the print request issuance unit 324, the documentation printer driver 236 generates the electronic document data and writhes the electronic document data in a predetermined area of a file system.

In addition, FIG. 6 illustrates a monitored folder 350, which is monitored by the document management system 110 for document registration. The monitored folder 350 is implemented by any desired memory such as the auxiliary memory 30. The documentation printer driver 236 outputs the electronic document data to the monitored folder 350 via a predetermined port to cause the monitored folder 350 to store stores the electronic document data. The document management system 110 periodically monitors the monitored folder 350. In response to detecting new electronic document data being stored in the monitored folder 350, the document management system 110 reads out the new electronic document data to incorporate it to the document management system 110. In the embodiments described herein, the electronic document data is registered to the document management system 110 via the monitored folder 350. However, this configuration for document registration is just one example. Alternatively, the document management system 110 may include an API for document registration that can be used by the documentation printer driver 236. In this case, the electronic document data can be registered to the document management system 110 with this API.

The setting of the print request issuance unit 324 as to whether to issue the output request to the actual printer driver 204, to the documentation printer driver 236, or to both of the actual printer driver 204 and the documentation printer driver 236 may be configured on a setting screen of the redaction control plug-in 234, for example. By configuring the print request issuance unit 324 to issue the print request and the documentation request respectively to the actual printer driver 204 and the documentation printer driver 236 at the same or substantially the same timing, the electronic document that has been output can be used later. For example, it is assumed that the same case (instance of specific medical condition) is output for several times. The electronic document data in which the proper noun such as the patient's name has been already redacted is stored for later printing out.

The description has been given heretofore of an example in which the intermediate-data edit unit 310, the proper noun extractor 322, the print request issuance unit 324, and the area designation information 326 are provided as the redaction control plug-in 234. However, this configuration is just one example. According to another embodiment, these components may be provided as a plurality of plug-ins. Alternatively, these components may be included in a plug-in or an application other than the redaction control plug-in 234.

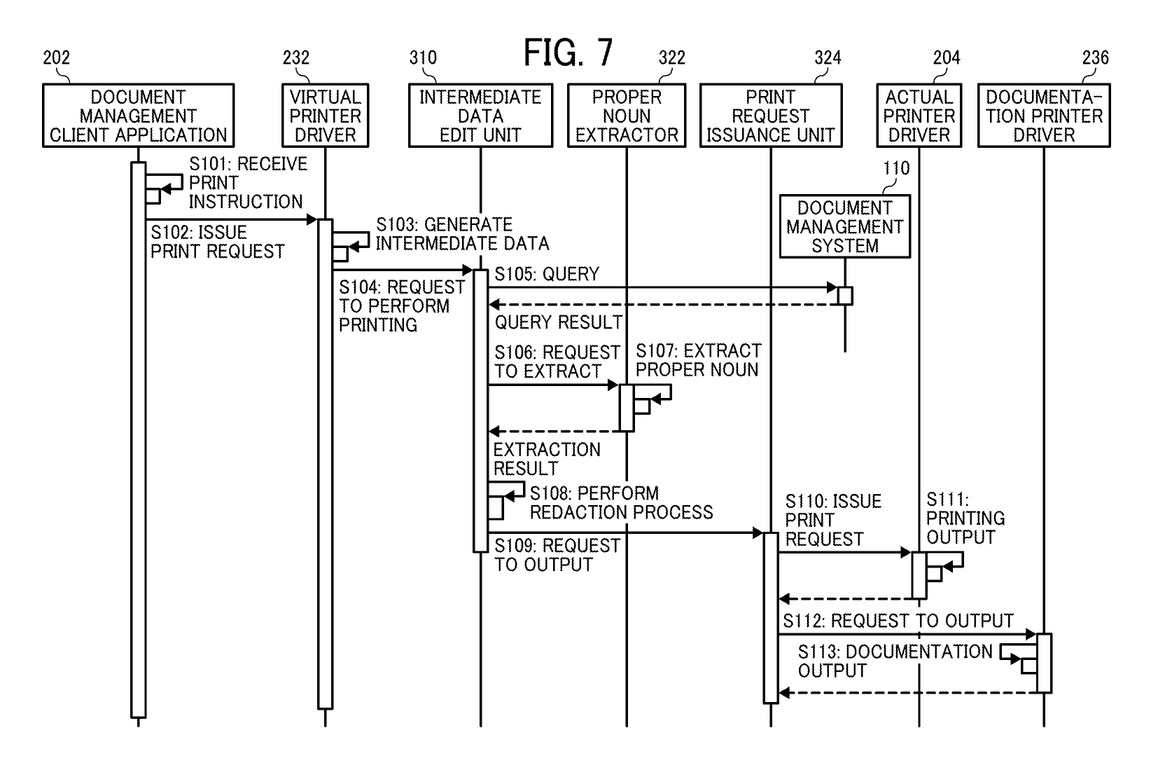

FIG. 7 is an outline sequence diagram illustrating the redaction process performed by the client terminal 112 according to this embodiment. First, at S101, the document management client application 202 receives a user instruction to print a predetermined document by the virtual printer driver 232.

At S102, the application 202 issues the print request based on the application data to the virtual printer driver 232. At S103, the virtual printer driver 232 converts the application data into the intermediate data. At S104, the virtual printer driver 232 requests the intermediate-data edit unit 310 to perform printing.

At S105, the intermediate-data edit unit 310 queries the document management system 110 for the confidential information relevant to the predetermined document to acquire the query result. At S106, the intermediate-data edit unit 310 passes the text to the proper noun extractor 322 to request the proper noun extractor 322 to extract the proper noun. At S107, the proper noun extractor 322 extracts the proper noun using at least one of morphological analysis and pattern matching and sends the extraction result back to the intermediate-data edit unit 310. At S108, the intermediate-data edit unit 310 performs the redaction processing based on the extraction result and deletes the confidential information that is acquired as the query result from the intermediate data.

At S109, the intermediate-data edit unit 310 instructs the print request issuance unit 324 to output the print request or the documentation request. At S110, the print request issuance unit 324 issues the print request to the actual printer driver 204 based on the edited intermediate data. At S111, in response to receiving the print request, the actual printer driver 204 generates the actual print data that can be output by the printer 122 and transmits the actual print data to the printer 122 to cause the printer 122 to print out the document.

In a case in which the user designate the documentation (output of electronic data), the processing proceeds to S112. At S112, the print request issuance unit 324 issues the documentation request to the documentation printer driver 236 based on the edited intermediate data. At S113, in response to the documentation request based on the edited intermediate data, the documentation printer driver 236 generates the electronic document data such as the PDF, and stores the generated electronic document data as a predetermined file in the monitored folder 350 or any desired memory. In another embodiment, the intermediate-data edit unit 310 may write attribute information (for example, a document identifier) identifying an original document from which the electronic document is generated to the same monitored folder 350 in which the electronic document data is stored, in association with the electronic document.

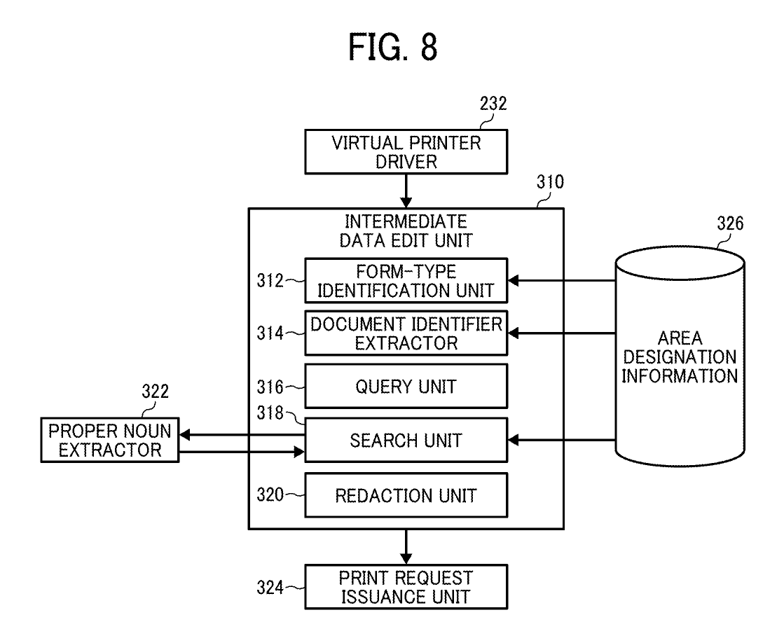

FIG. 8 is a block diagram illustrating detailed functional blocks relevant to the redaction process implemented on the client terminal 112. As illustrated in FIG. 8, the intermediate-data edit unit 310 more specifically includes a form-type identification unit 312, a document-identifier extractor 314, a query unit 316, a search unit 318, and a redaction unit 320. Furthermore, FIG. 8 illustrates the virtual printer driver 232, the proper noun extractor 322, the print request issuance unit 324, and the area designation information 326, as the functional blocks that operate in cooperation with the intermediate-data edit unit 310.

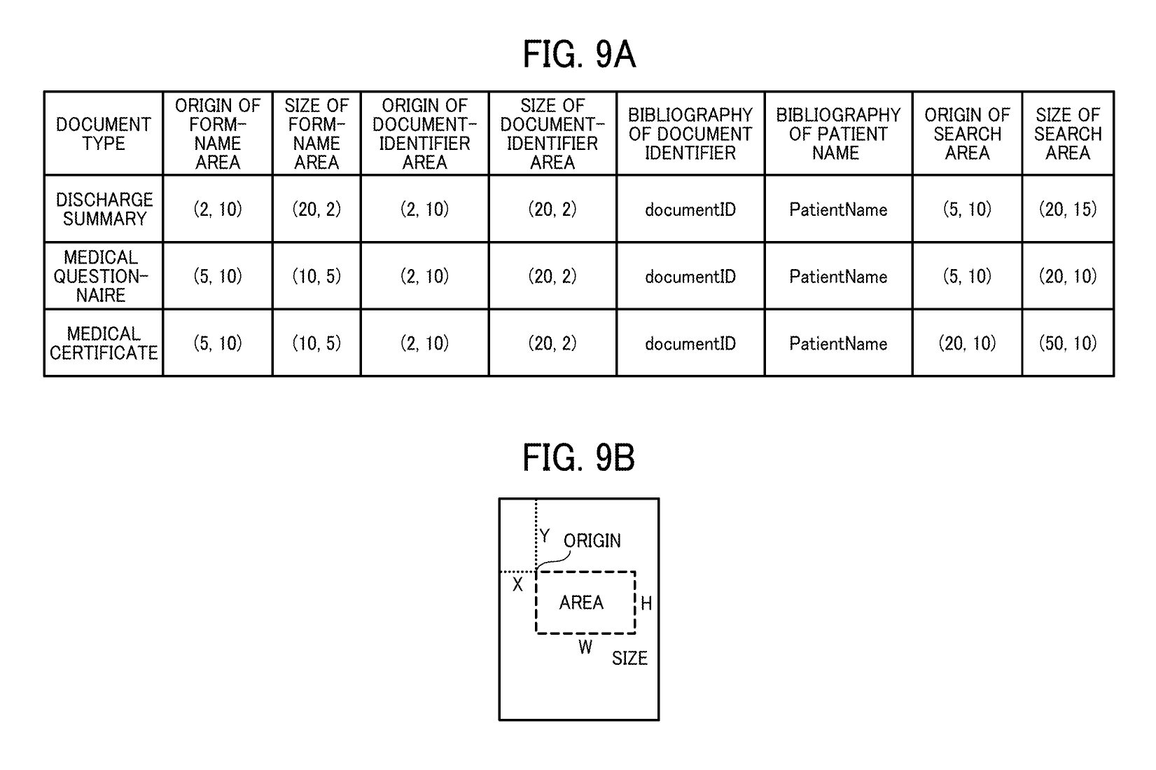

FIG. 9A is a view illustrating an example of data structure of the area designation information 326 according to this embodiment. As illustrated in FIG. 9A, the area designation information 326 contains a plurality of records, each containing various pieces of information, in association with a plurality of document types. Each record includes a column for storing a document type, and two columns for storing an origin and a size, respectively, that define a form-name area containing a form name that indicates the document type. Further, each record includes two columns for storing an origin and a size, respectively, that define a document-identifier area containing a document identifier that identifies a document. Furthermore, each record includes a column for storing a document identifier bibliography indicating a management name of the document identifier in the document management system 110, and a column for storing a patient's name bibliography indicating a management name of a patient's name for example, which is the confidential information in the document management system 110. Still further, each record includes two columns for storing an origin and a size respectively that define the search area to be searched for the confidential information in the intermediate data. In the embodiments described herein, each area is defined by the origin (X, Y) and the size (W, H), as illustrated in FIG. 9B. A character string is assigned to the document as the document identifier. The character strings assigned to different documents do not overlap with each other in the document management system 110.

In another embodiment, the area designation information 326 may include information specifying an area to be redacted unconditionally (without searching). With this configuration, in addition to the area in which the contained text is analyzed and the information extracted based on the analysis result, an area is set in which all contained characters are deleted. Most types of forms include, as a template, a fixed area in which the patient name and the like is input and an area in which free text is input. In this case, for example, the fixed area in which the patient name is input is redacted without text analysis to improve efficiency.

Referring back to FIG. 8, the form-type identification unit 312 identifies the document type based on the intermediate data. The form-type identification unit 312 tries to extract a character string indicating the form name from the form-name area defined by the origin and the size illustrated in FIG. 9A. Further, the form-type identification unit 312 identifies the document type based on the extracted character string. When the form-type identification unit 312 finds the character string indicating a predetermined form in the form-name area defined for the predetermined form, the form-type identification unit 312 identifies the predetermined form.

The document-identifier extractor 314 extracts the document identifier from the intermediate data based on the identified document type. The document-identifier extractor 314 tries to extract a character string indicating the document identifier from the document-identifier area defined by the origin and the size illustrated in FIG. 9A. Further, the document-identifier extractor 314 acquires the document identifier based on the extracted character string. Note that the document identifier is extracted from an area corresponding to the document type.

The query unit 316 queries the document management system 110 for the confidential information relevant to the document based on the extracted document identifier. The query unit 316 queries the document management system 110 using the extracted document identifier and the document identifier bibliography corresponding to the identified form illustrated in FIG. 9A. The query unit 316 acquires the patient's name stored in the patient′ name bibliography corresponding to the identified form illustrated in FIG. 9A based on the query result and determines the acquired patient's name as the confidential information.

The search unit 318 sets the search area according to the identified document type and retrieves the confidential information (information of protection target) from the intermediate data. The search unit 318 sets the search area defined by the origin and the size corresponding the identified form illustrated in FIG. 9A to retrieve the acquired confidential information (patient's name). The search unit 318 may cooperate with the proper noun extractor 322 to retrieve the acquired confidential information (patient's name) based on the result obtained by performing the morphological analysis or the pattern matching.

The redaction unit 320 deletes the confidential information in the intermediate data based on the query result received from the document management system 110. In the embodiments described herein, the redaction unit 320 replaces each character of the confidential information (patient's name) with a mask character such as a black square or overlays a black image on all of a word, to delete the confidential information. These are just examples of deleting the confidential information. Alternatively, the redaction unit 320 may replace the confidential information with nonce information to implement the deletion. For example, each person's name may be replaced with information that does not identify a person while distinguishable over nonce information such as “Mr. A”, “Mr. B”, “Patient C”, or “Patient D”. Still alternatively, each person's name may be replaced with information that specifies a part of the person's attributes, such as “patient” or “doctor”, as needed.

The print request issuance unit 324 transmits, to the actual printer driver 204, the intermediate data that is edited by the redaction unit 320 to include the redacted patient's name. Accordingly, the edited intermediate data is output for printing on a recording medium such as a sheet of paper. Note that although a description has been given heretofore of an example in which the confidential information is the patient's name, the patient's name is just one example of the confidential information. Alternatively, a doctor's name or a hospital's name may be a target to be protected. Further, any type of information may the target to be protected depending on the environment in which the printing system 100 operates.

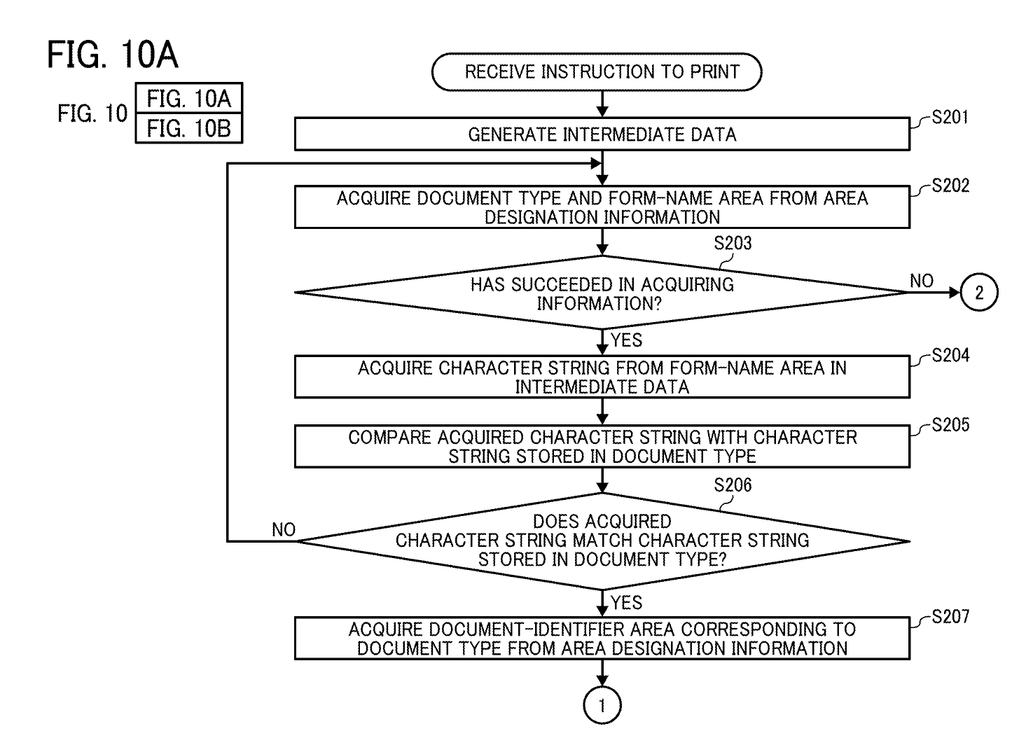

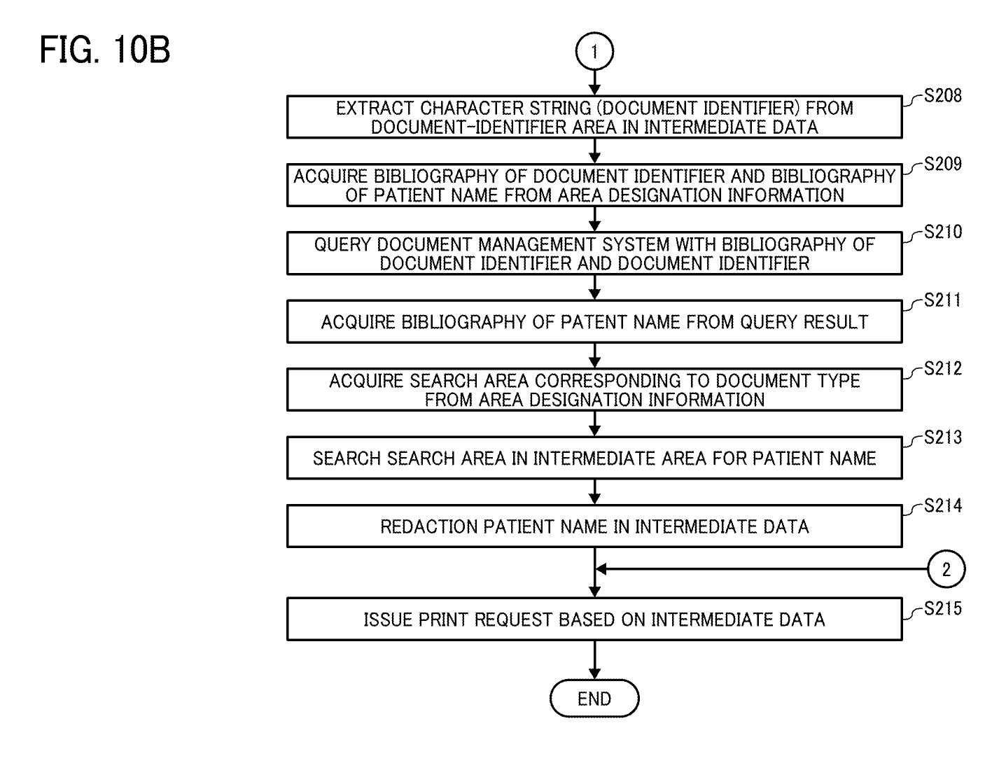

FIGS. 10A and 10B are a flowchart illustrating a detailed operation of the redaction process performed by the client terminal 112 according to this embodiment. First, at 5200, the virtual printer driver 232 receives the print request from the document management client application 202.

At 5201, the virtual printer driver 232 converts the application data into the intermediate data. At 5202, the form-type identification unit 312 of the intermediate-data edit unit 310 acquires the “document type”, the “origin of form-name area”, and the “size of form-name area” from the area designation information 326. At S203, the form-type identification unit 312 determines whether the form-type identification unit 312 has succeeded in acquiring these pieces of information. When the form-type identification unit 312 determines that it has succeeded in acquiring these pieces of information and that any other record remains unprocessed (S203: YES), the processing proceeds to S204.

At S204, the form-type identification unit 312 acquires the character string from the area defined by the “origin of form-name area” and the “size of form-name area” in the intermediate data based on the position information of characters in the intermediate data. At S205, the form-type identification unit 312 compares the acquired character string with the character string stored in the “document type”. At S206, the form-type identification unit 312 compares the acquired character string with the character string stored in the “document type”. When the form-type identification unit 312 determines that the acquired character string and the character string stored in the “document type” do not match (S206: NO), the processing returns to S202 for processing the next record. By contrast, when the acquired character string matches the character string stored in the “document type” (S206: YES), the processing proceeds to S207.

At S207, the document-identifier extractor 314 acquires the “origin of document-identifier area” and the “size of document-identifier area” corresponding to the matched “document type” from the area designation information 326. At S208, the document-identifier extractor 314 extracts the character string from the document-identifier area defined by the “origin of document-identifier area” and the “size of document-identifier area” in the intermediate data based on the position information of characters in the intermediate data to determine the extracted character string as the document identifier.

At S209, the query unit 316 acquires the “bibliography of the document identifier” and the “bibliography of the patient's name” from the area designation information 326. At S210, the query unit 316 queries the document management system 110 with a set of a key of “bibliography of document identifier” and the document identifier to acquire the query result from the document management system 110. At S211, the query unit 316 acquires a value corresponding to the key of the bibliography of patient's names as the patient's name to determine the acquired patient's name as the confidential information.

At S212, the search unit 318 acquires the “origin of search area” and the “size of search area” corresponding to the “document type”. At S213, the search unit 318 retrieves the portion corresponding to the patient's name from the search area defined by the “origin of search area” and the “size of search area” in the intermediate data based on the position information of the text in the intermediate data. At S214, the redaction unit 320 performs the redaction process on the portion corresponding to the patient's name in the intermediate data. At S215, the print request issuance unit 324 issues the print request based on the edited intermediate data. At S216, the processing ends.

By contrast, at S203, when the form-type identification unit 312 determines that all of the records have been processed, that is, no record remains to be processed, and the acquisition of the information has failed (S203: NO), the processing proceeds to S215. In this case, at S215, the print request issuance unit 324 issues the print request based on the original intermediate data. At S216, the processing ends. In the embodiments described herein, a description is given of an example in which the document is output without the redaction process when the document does not correspond to any form. However, this processing is just one example. Alternatively, the output of the document may be canceled when the document does not correspond to any form. Still alternatively, a pop-up screen may be displayed for requesting a user to authorize the continuation of printing, when the document does not correspond to any form.

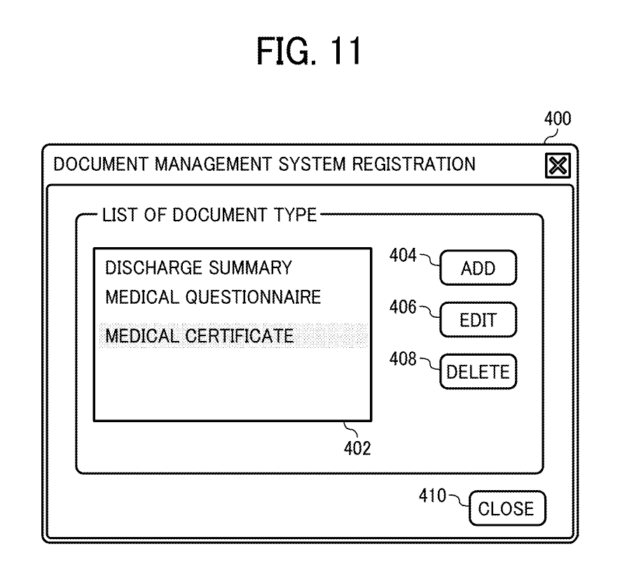

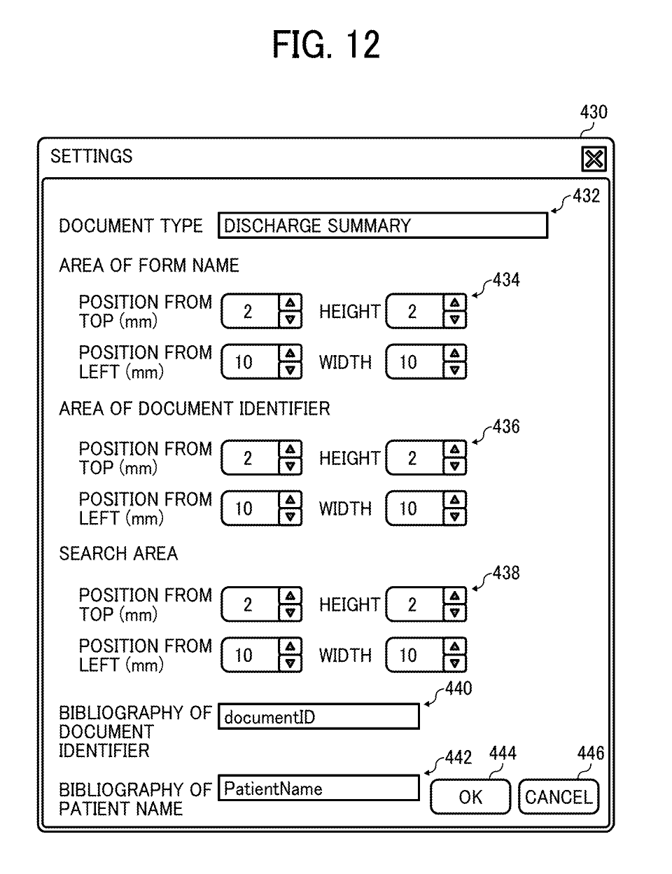

FIGS. 11 and 12 each illustrate a graphical user interface (GUI) for setting the area designation information as illustrated in FIG. 9A. FIG. 11 illustrates an example of a document-type-list screen displaying a list of document types. The screen 400 illustrated in FIG. 11 allows a user to register a new document type, edit the document type that has been already registered, or delete the document type that has been already registered, as the area designation information.

As illustrated in FIG. 11, the document-type-list screen 400 includes a list box 402, a new registration key 404, an edit key 406, a delete key 408, and a close key 410. The list box 402 displays a list of document types that have been already registered.

In response to the new registration key 404 being pressed, the screen 400 transits to a document-type setting screen 430 as illustrated in FIG. 12 that allows a user to enter detailed information of the new document type. In response to the edit key 406 being pressed while one of the document types is selected in the list box 402, the screen 400 also transits to the document-type setting screen 430 as illustrated in FIG. 12 that allows the user to edit detailed information of the selected document type.

Further, in response to the delete key 408 being pressed while one of the document types is selected in the list box 402, the registration of the selected document type is deleted. In response to the close key 410 being pressed, the screen 400 is closed.

FIG. 12 illustrates an example of the document-type setting screen 430 for setting detailed contents of the document type. As illustrated in FIG. 12, the document-type setting screen 430 includes a text box 432 in which the user enters a name of the document type. The document-type setting screen 430 further includes numeric box groups 434, 346 and 438, each group enabling the user to define each area. The document-type setting screen 430 still further includes two text boxes 440 and 442 in which the user enters the bibliographic information for the query in the document management system 110. The document-type setting screen 430 still further includes an OK key 444 and a cancel key 446.

The numeric box group 434 is a GUI part to enable the user to enter the origin and the size defining the form-name area. The numeric box group 436 is a GUI part to enable the user to enter the origin and the size defining the document-identifier area. The numeric box group 438 is a GUI part to enable the user to enter the origin and the size defining the search area. The text box 440 is a GUI part in which the user enters the document identifier bibliography to be queried. The text box 442 is a GUI part in which the user enters the patient's name bibliography to be acquired from the query result.

When the document-type setting screen 430 is displayed in response to the pressing of the new registration key 404, a predefined value is displayed in each GUI. By contrast, when the document-type setting screen 430 is displayed in response to the edit key 406 being pressed, a present value of the corresponding document type is displayed in each GUI.

In response to the OK key 444 being pressed after various values are entered in the GUIs on the document-type setting screen 430 illustrated in FIG. 12, the new document type is registered with the entered values, or the existing (already-registered) document type is updated with the entered values. In response to the cancel key 446 being pressed, the screen 430 is closed without reflecting the entered values, and the screen 400 illustrated in FIG. 11 is again displayed.

According to the embodiment described heretofore, the confidential information is detected effectively, and the detected confidential information is prevented from being output unintentionally. Especially, as an outside document management system such as an electronic health record system stores various useful information in association with a document, a client terminal acquires the bibliographic information managed by the document management system and uses the acquired bibliographic information as a keyword for deletion to delete the confidential information from the output content effectively and accurately. Accordingly, the confidential information is prevented from being output unintentionally.

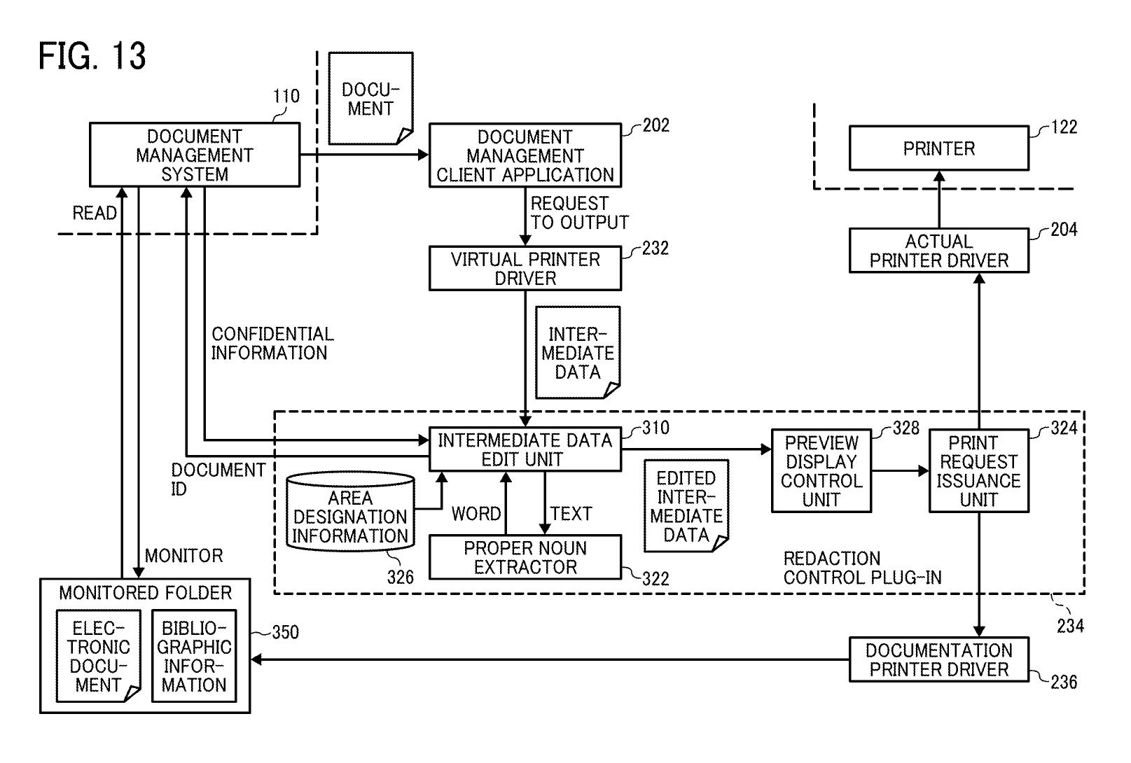

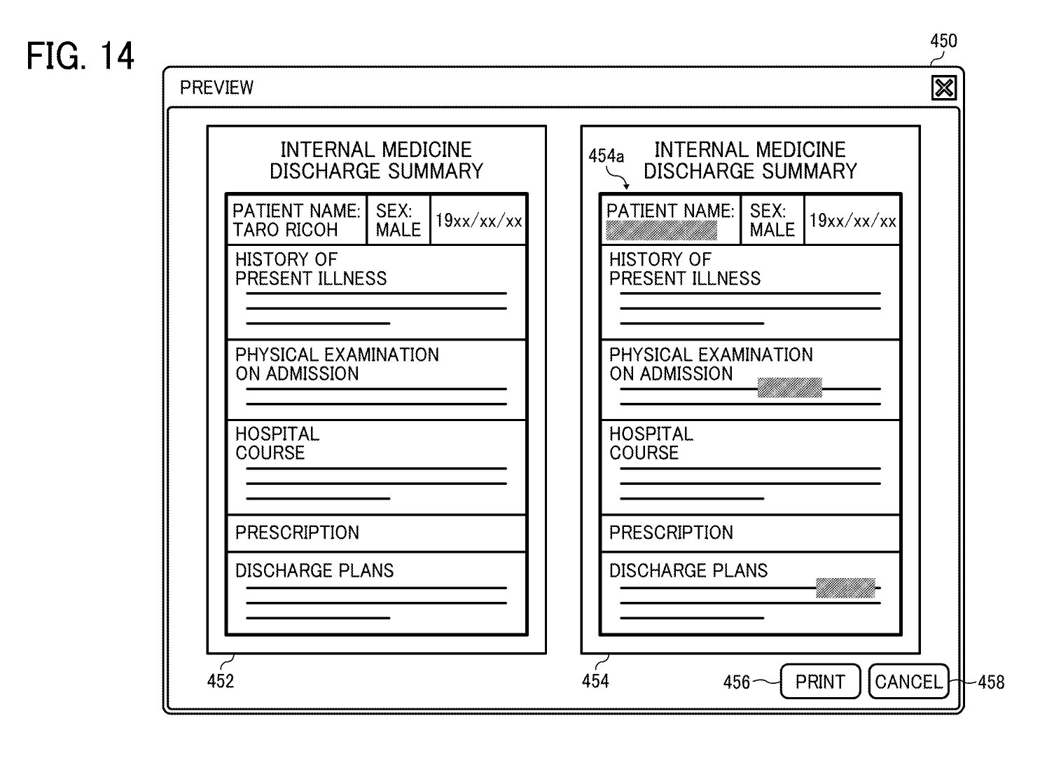

Hereinafter, a description is given of the printing system 100 according to another embodiment with reference to FIGS. 13 and 14. In the above embodiment described with reference to FIGS. 1 to 12, the redaction control plug-in 234 automatically detects the confidential information, redacts the detected confidential information, and issues the output request to at least one of the actual printer driver 204 and the documentation printer driver 236 based on the edited intermediate data. By contrast, in the embodiment illustrated in FIGS. 13 and 14, the redaction control plug-in 234 displays a preview screen after detecting and redacting the confidential information. The redaction control plug-in 234 allows the user to interact with the client terminal 112 via the preview screen before issuing the output request (print request or documentation request).

FIG. 13 is a block diagram illustrating functional blocks relevant to the redaction process implemented on the client terminal 112 according to another embodiment. FIG. 13 illustrates a preview-display control unit 328 included in the redaction control plug-in 234 in addition to the components and functional blocks 202, 204, 232, 234, 236, and 310 to 326 illustrated in FIG. 6.

The preview-display control unit 328 displays a preview indicating a predicted result of the output processing based on the edited intermediate data from which the confidential information has been deleted before issuing the output request.

In this embodiment, the intermediate-data edit unit 310 cooperates with the document management system 110 to edit the intermediate data such that the predetermined information contained in the text of the intermediate data is redacted, in substantially the same manner as the above embodiment described with reference to FIGS. 1 to 12.

After the intermediate-data edit unit 310 edits the intermediate data, the preview-display control unit 328 displays the output preview screen to enable the user to recognize and check the predicted result of the output processing. This display of the preview screen is performed before the print request is output to the actual printer driver 204 from the print request issuance unit 324.

FIG. 14 illustrates an example of an output preview screen 450 provided by the redaction control plug-in 234 according to this embodiment. The output preview screen 450 includes a print preview 452 that is displayed based on the original intermediate data on which the redaction processing has not been performed, and a print preview 454 that is displayed based on the edited intermediate data. As illustrated in FIG. 14, the preview result before the redaction processing and the preview result after the redaction processing are displayed side by side, thereby making it easy for the user to compare the results.

On the output preview screen 450 illustrated in FIG. 14, the confidential information is redacted in the print preview 454 based on the edited intermediate data. Instead of redacting the confidential information as a redacted portion 454a, the confidential information may be highlighted by shading or in red, thereby enabling the user to recognize the original character string.

Further, in another embodiment, the output preview screen 450 may allow the user to cancel the deletion setting of the redacted information in the predicted result and/or to add the deletion setting of information contained in the predicted result. For example, the user checks the predicted result in the print preview 454 on the output preview screen and corrects the confidential information detected by the intermediate-data edit unit 310 as needed. More specifically, the user selects the redacted portion 454a with the mouse 54, for example. For example, the user presses a delete key while selecting the redacted portion 454a to cancel the redacting and make the redacted information (character string) to appear. In addition, or alternatively, the user may select a portion or character string that is not redacted by dragging the mouse 54 to add redaction to the selected portion or character string.

The output preview screen 450 includes a print key 456. In response to the print key 456 being pressed, the print request issuance unit 324 issues the print request to the actual printer driver 204 based on the edited intermediate data from which the confidential information is deleted. Further, the print request issuance unit 324 issues the documentation request to the documentation printer driver 236 at the same or substantially the same timing of the issuance of the print request to the actual printer driver 204, as needed.

According to this embodiment, the user is able to visually check the redacted status and correct the redacted content as needed. Thus, the document is output with the confidential information being deleted with accuracy.

As described heretofore, according to the described embodiments, in processing the output of the document, the confidential information is detected effectively, and the detected confidential information is prevented from being output unintentionally.

Each function block in the embodiments may be implemented by a program described in program languages such as an assembler language and C, and object-oriented program languages such as C++, C# and Java (registered trademark). The program may be provided using any storage medium that is readable by an apparatus, such as a ROM, erasable programmable read-only memory (EPROM), an electrically erasable PROM, a flash memory, a flexible disc, a compact disc (CD) ROM, a CD-RW, a DVD-ROM, a DVD-RAM, a DVD-RW, a Blu-ray disc, a SD card, and a magneto-optical disc (MO). Alternatively, the program may be distributed via an electric communication network.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing apparatus communicably connected to an information management system, the apparatus comprising circuitry configured to:
generate intermediate data of a document in response to receiving a request for outputting the document;
query the information management system for confidential information relevant to the document;
delete the confidential information contained in the intermediate data, the confidential information being determined based on a result of the query from the information management system; and
issue an output request for performing output processing based on the intermediate data having the confidential information deleted.

2. The information processing apparatus claim 1, wherein the circuitry is further configured to:
identify a document type of the document based on the intermediate data;
extract a document identifier from the intermediate data based on the identified document type; and
query the information management system for confidential information relevant to the document based on the extracted document identifier.

3. The information processing apparatus of claim 2, wherein the circuitry is further configured to retrieve the confidential information from a search area in the intermediate data, the search area being previously set based on the identified document type.

4. The information processing apparatus of claim 3, wherein the circuitry analyzes text included in the intermediate data using at least one of morphological analysis and pattern matching and retrieves the confidential information from the text based on the analysis.

5. The information processing apparatus of claim 1, wherein the circuitry further generates an electronic document in response to the output request based on the intermediate data.

6. The information processing apparatus of claim 5, wherein the circuitry is further configured to store, in a storage area, attribute information relevant to the document from which the electronic document is generated in association with the electronic document.

7. The information processing apparatus of claim 1, wherein the circuitry is further configured, before issuing the output request, to display a preview screen that displays a predicted result of the output processing based on the intermediate data having the confidential information deleted.

8. The information processing apparatus of claim 7, wherein the preview screen allows a user to modify the confidential information to be deleted.

9. The information processing apparatus of claim 1, wherein the circuitry redacts the confidential information or replaces the confidential information with other information to delete the confidential information.

10. The information processing apparatus of claim 1, further comprising a memory to store, for each one of a plurality of document types of the document, at least one of:
a specification of an area in the document, which contains information indicating the document type;
a specification of an area in the document, which contains information identifying the document;
a management name of the information identifying the document in the information management system;
a management name of the confidential information in the information management system;
a search area to be searched for the confidential information in the intermediate data of the document; and
a specification of an area to be deleted in the document, without searching.

11. The information processing apparatus of claim 1, wherein:
the circuitry installs a virtual printer driver to execute the generating of the intermediate data, and a plug-in to execute the deleting of the confidential information and the issuing of the output request.

12. An information processing method performed by an information processing apparatus communicably connected to an information management system, the method comprising:
generating intermediate data of a document in response to receiving a request for outputting the document;
querying the information management system for confidential information relevant to the document;
deleting the confidential information contained in the intermediate data, the confidential information being determined based on a result of the query from the information management system; and
issuing an output request for performing output processing based on the intermediate data having the confidential information deleted.

13. A non-transitory computer-readable medium storing a computer-executable program that, when executed, causes an information processing apparatus communicably connected to an information management system to perform an information processing method comprising:
generating intermediate data of a document in response to receiving a request for outputting the document;
querying the information management system for confidential information relevant to the document;
deleting the confidential information contained in the intermediate data, the confidential information being determined based on a result of the query from the information management system; and
issuing an output request for performing output processing based on the intermediate data having the confidential information deleted.
